(19) United States
(12) Patent Application Publication
(10) Pub. No.: US 2017/0046692 A1
(43) Pub. Date: Feb. 16, 2017

(54) Systems and Methods for Facilitating Purchase Transactions Funded by Rewards

(71) Applicant: MASTERCARD INTERNATIONAL INCORPORATED, Purchase, NY (US)

(72) Inventor: Wayne A. Borgmeyer, Wentzville, MO (US)

(21) Appl. No.: 14/821,960

(22) Filed: Aug. 10, 2015

(51) Int. Cl. G06Q 20/38; G06Q 30/02

(52) U.S. Cl. CPC G06Q 20/387; G06Q 30/0233

(57) ABSTRACT

Systems and methods are provided for facilitating purchase of products using rewards for a payment account associated with a consumer. In one example, a method generally includes receiving a product indicia associated with a target product offered for sale by a merchant, as scanned by a portable communication device, and sending, in response to the indicia, data corresponding to an identified product associated with the product indicia, from a reward library. The corresponding data further includes a reward cost associated with the identified product and a reward balance for a payment account associated with the consumer. The method further includes receiving, from the portable communication device, a request for a purchase of the identified product using rewards for the payment account, and communicating a transaction request for the product to the merchant, when the product is offered for sale by the merchant, and/or to an issuer of the payment account.

### FIELD

The present disclosure generally relates to facilitating purchase transactions funded by rewards, and in particular, to scanning products offered at merchants, and then facilitating purchase transactions for the products, or products similar to or useful with the products, from the merchants or elsewhere using rewards from reward accounts.

### BACKGROUND

This section provides background information related to the present disclosure which is not necessarily prior art.

Consumers often use payment devices, associated with payment accounts, to purchase products (e.g., goods and/or services, etc.) from merchants. The payment accounts are issued by issuers, who often provide rewards (e.g., points, miles, etc.) to the consumers for purchases made with the payment accounts. The rewards are based on total amounts, or values, of the purchases made with the payment devices and processed to the payment accounts, and may be redeemed to purchase products. Separately, some merchants are known to have websites (e.g., associated with businesses operated by the merchants, or otherwise associated with information disseminated by the merchants, etc.) that are viewable online, and that consumers can find, for example, via searches through one or more search engines.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use to facilitate purchase transactions funded by rewards;

FIG. 2 is a block diagram of a computing device, which may be used in the exemplary system of FIG. 1; and

FIG. 3 is an exemplary method for facilitating a purchase transaction by a consumer funded by rewards earned by the consumer, which may be implemented in connection with the system of FIG. 1.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Consumers often use payment accounts to purchase products (e.g., goods and/or services, etc.) from merchants. Frequently, the payment accounts are provided to the consumers by issuers who then assign rewards to the consumers based on transactions to the payment accounts. The rewards, which have little to no inherent cash value, are redeemable for cash, or products in reward libraries offered by the issuers or merchants (e.g., airline tickets, etc.), etc. The systems and methods herein allow consumers to scan products displayed at merchants (whether at physical merchant locations, or at virtual merchant locations, etc.) and then, based on the scan, identify the same products, similar products, and/or related products for purchase through the merchants or others using, at least partly, rewards earned by the consumers through use of their payment accounts. Identification of the various products may be based on searches in reward libraries or catalogs provided by the issuers or rewards providers, for example, or by the merchants at which the products were scanned, and/or by other merchants or other parties, any of which may provide reward costing for the products (e.g., discounted costs, etc.) and/or provide for purchase transactions funded by rewards.

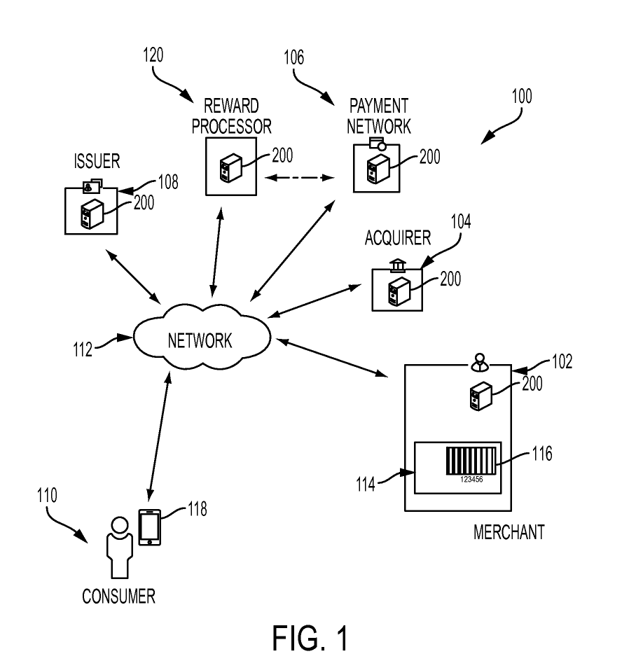

FIG. 1 illustrates an exemplary system 100 in which one or more aspects of the present disclosure may be implemented. Although parts of the system 100 are presented in one arrangement, it should be appreciated that other exemplary embodiments may include the same or different parts arranged otherwise depending, for example, on interactions and/or relationships between various parts when processing transactions, in general or funded by rewards.

The illustrated system 100 generally includes a merchant 102, an acquirer 104, a payment network 106, an issuer 108, and a consumer 110, each coupled to network 112. The network 112 may include, without limitation, a wired and/or wireless network, a local area network (LAN), a wide area network (WAN) (e.g., the Internet, etc.), a mobile network, and/or another suitable public and/or private network capable of supporting communication among two or more of the illustrated parts of the system 100, or any combination thereof. In one example, the network 112 includes multiple networks, where different ones of the multiple networks are accessible to different ones of the illustrated components in FIG. 1. In one example, the acquirer 104, the payment network 106, and the issuer 108 are connected via a private payment network for processing payment transactions, and the merchant 102 and the consumer 110 are connected through a public network, such as the Internet.

Generally in the system, the merchant 102, the acquirer 104, the payment network 106, and the issuer 108 cooperate, in response to the consumer 110 (e.g., a purchase by the consumer 110), to complete a purchase transaction. In the exemplary embodiment, the consumer 110 initiates the transaction by presenting a payment device, such as a credit card, a debit card, a pre-paid card, a payment token, a payment tag, a pass, another device used to provide an account number (e.g., a mobile phone, a tablet, etc.), etc., to the merchant 102.

In the purchase transaction by the consumer 110, for example, the merchant 102 reads the payment device (associated with the payment account) and communicates an account number and an amount of the purchase to the acquirer 104 through the network 112 (specifically, through a private payment network component of the network 112 such as provided by MasterCard®, etc.) to determine if the payment account is in good standing and if there is sufficient credit/funds to complete the transaction. The acquirer 104, in turn, communicates with the issuer 108, through the payment network 106, via the network 112 (again through the private payment network component of the network 112), for authorization for the transaction. If the issuer 108 accepts the transaction, an authorization is provided back to the merchant 102 and the merchant 102 completes the transaction. The credit line or funds of the consumer 110, depending on the type of payment account, is then decreased by the amount of the purchase, and the charge is posted to the account associated with the payment device. The transaction is later cleared and settled by and between the merchant 102 and the acquirer 104 (in accordance with a settlement arrangement, etc.), and by and between the acquirer 104 and the issuer 108 (in accordance with another settlement arrangement, etc.). Certain accounts, such as debit payment accounts, may further include the use of a personal identification number (PIN) authorization and more rapid posting of the charge to the account associated with the card, etc.

Further, based on the purchase transaction, rewards (e.g., reward points or other rewards, etc.) are assigned to the consumer's payment account, for example, based on the amount of the purchase, the product(s) involved in the purchase transaction, the merchant 102, and/or other factors, etc. For example, the earned rewards may be assigned to, accumulated in and tracked through a reward account associated with the consumer's payment account. The rewards can then be subsequently redeemed from the reward account as desired (e.g., for products, etc.). Much like the consumer's payment account accumulates a balance due for credit transactions, and/or much like the consumer 110 manages an account balance for prepaid or debit accounts, the reward account can be managed for the rewards assigned based on use of the payment account.

Transaction data is generated, collected, and stored as part of the above interactions among the merchant 102, the acquirer 104, the payment network 106, the issuer 108, and the consumer 110. The transaction data represents at least a plurality of transactions, e.g., completed transactions, attempted transactions, earned rewards, etc. The transaction data, in this exemplary embodiment, is stored at least by the payment network 106 (e.g., in a data structure associated with the payment network 106, etc.). Additionally, or alternatively, the merchant 102, the acquirer 104, and/or the issuer 108 may store the transaction data, or part thereof, in a data structure. Further, transaction data may be transmitted between entities of system 100, as used or needed. The transaction data may include, for example, amounts of transactions, merchant IDs, merchant category codes, dates/times of transactions, products purchased and related descriptions or identifiers, rewards earned, reward balances, product returns/refunds, etc. It should be appreciated that more or less information related to transactions, as part of either authorization and/or clearing and/or settling, may be included in transaction data and stored within the system 100, at the merchant 102, the acquirer 104, the payment network 106, and/or the issuer 108.

In various exemplary embodiments, consumers (e.g., consumer 110, etc.) involved in the different transactions herein, are prompted to agree to legal terms associated with their payment accounts, for example, during enrollment in their accounts, etc. In so doing, the consumers may voluntarily agree, for example, to allow merchants, issuers of the payment accounts, payment networks, etc., to use data collected during enrollment and/or collected in connection with processing the transactions, subsequently for one or more of the different purposes described herein.

As previously described, the merchant 102 offers various products for sale to the consumer 110. As shown in FIG. 1, the merchant includes a product 114, which is marked with product indicia 116 (or other symbol, etc.) that can be used to identify the product 114 (e.g., by serial number, by manufacturer, by universal product code (UPC), by stock keeping unit (SKU) code, by combinations thereof, etc.). The product 114 may include any product offered for sale by the merchant 102, at a brick-and-mortar location of the merchant 102 or virtually via a web-application associated with the merchant 102. In addition, the product indicia 116, although illustrated as a barcode in FIG. 1, may include any suitable indicia indicative of, or descriptive of, the product 114 and suitable to be scanned or otherwise recognized. For example, in other embodiments the indicia 116 may include a QR code, barcodes other than illustrated, text characters, numerical characters, other symbols, etc. Further, the scanning may take place on physical items (e.g., packaging, advertising banners, etc.) using suitable scanners, cameras or other inputs devices, etc., or on digital representations of the items (e.g., at web pages, on digital images of the items, at product information applications, etc.) using cameras, scanners or other input devices, etc. It should be appreciated that, while the merchant 102 is illustrated as separate from the issuer 108 in FIG. 1, in instances where products are offered in exchange for rewards directly by the issuer 108, the issuer 108 may be considered a merchant, for example, consistent with merchant 102.

Further, while only one merchant 102, one acquirer 104, one payment network 106, one issuer 108, one consumer 110, and one product 114 are illustrated in FIG. 1 (for ease of reference), it should be appreciated that a variety of other embodiments may include multiple ones of these parts in various combinations and, in some of these embodiments, hundreds or thousands of certain ones of these parts.

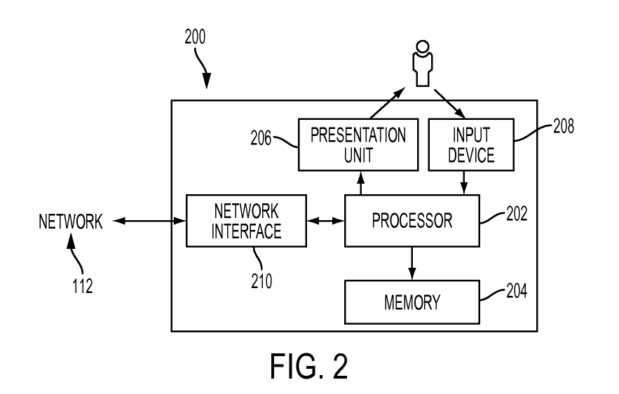

FIG. 2 illustrates an exemplary computing device 200 that can be used in the system 100. The computing device 200 may include, for example, one or more servers, workstations, personal computers, laptops, tablets, smartphones, point of sale (POS) terminals, other suitable computing devices, etc. In addition, the computing device 200 may include a single computing device, or it may include multiple computing devices located in close proximity, or multiple computing devices distributed over a geographic region. However, the system 100 should not be considered to be limited to the computing device 200, as described below, as different computing devices and/or arrangements of computing devices may be used. In addition, different components and/or arrangements of components may be used in other computing devices. Further, in various exemplary embodiments, the computing device 200 may include multiple computing devices located in close proximity, or distributed over a geographic region (such that each computing device 200 in the system 100 may represent multiple computing devices, etc.). Additionally, each computing device 200 illustrated in the system 100 may be coupled to a network (e.g., the Internet, an intranet, a private or public LAN, WAN, mobile network, telecommunication networks, combinations thereof, or other suitable network, etc.) that is either part of the network 112, or separate therefrom.

In the exemplary embodiment of FIG. 1, each of the merchant 102, the acquirer 104, the payment network 106, and the issuer 108 are illustrated as including, or being implemented in, computing device 200, coupled to the network 112. Also in the exemplary embodiment of FIG. 1, the consumer 110 is associated with a portable communication device 118, which is consistent with computing device 200.

Referring to FIG. 2, the illustrated computing device 200 generally includes a processor 202, and a memory 204 that is coupled to the processor 202. The processor 202 may include, without limitation, one or more processing units (e.g., in a multi-core configuration, etc.), including a general purpose central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein. The above examples are exemplary only, and are not intended to limit in any way the definition and/or meaning of processor.

The memory 204, as described herein, is one or more devices that enable information, such as executable instructions and/or other data, to be stored and retrieved. The memory 204 may include one or more computer-readable media, such as, without limitation, dynamic random access memory (DRAM), static random access memory (SRAM), read only memory (ROM), erasable programmable read only memory (EPROM), solid state devices, CD-ROMs, thumb drives, tapes, flash drives, hard disks, and/or any other type of volatile or nonvolatile physical or tangible computer-readable media. The memory 204, and/or data structures included therein, may be configured to store, without limitation, data relating to payment accounts, data for transactions processed to the payment accounts, data relating to reward accounts, data relating to reward values assigned to products, data relating to products, and/or any other types of data suitable for use as described herein, etc.

Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer-readable media. It should be appreciated that the memory 204 may include a variety of different memories, each implemented in one or more of the functions or processes described herein.

The illustrated computing device 200 also includes a presentation unit 206 (or output device) that is coupled to the processor 202. The presentation unit 206 outputs, or presents, to a user (e.g., one or both of the consumers 110 in the system 100; individuals associated with one or more of the merchant 102, the acquirer 104, the payment network 106, and the issuer 108 in the system 100; individuals associated with reward provider 120 in the system 100; etc.) by, for example, displaying, audibilizing, and/or otherwise outputting data such as, but not limited to, data relating to payment accounts, data for transactions processed to the payment accounts, data relating to products offered by the merchant 102, data relating to reward accounts, and/or any other type of data. It should be further appreciated that, in some embodiments, the presentation unit 206 comprises a display device such that various interfaces (e.g., applications, webpages, etc.) may be displayed at computing device 200, and in particular at the display device, to display such information and data, etc. And in some examples, the computing device 200 may cause the interfaces to be displayed at a display device of another computing device, including, for example, a server hosting a website having multiple webpages, etc. With that said, presentation unit 206 may include, without limitation, a liquid crystal display (LCD), a light-emitting diode (LED) display, an organic LED (OLED) display, an “electronic ink” display, speakers, combinations thereof, etc. In some embodiments, presentation unit 206 includes multiple units.

The computing device 200 further includes an input device 208 that receives input from the user of the computing device 200 (i.e., user inputs) such as, for example, product scans, etc. The input device 208 is coupled to the processor 202 and may include, for example, a keyboard, a pointing device, a mouse, a stylus, a barcode reader, a QR code reader, a touch sensitive panel (e.g., a touch pad or a touch screen, etc.), a camera, another computing device, and/or an audio input device. Further, in some exemplary embodiments, a touch screen, such as that included in a tablet, a smartphone, or similar device, behaves as both a presentation unit and an input device. In at least one exemplary embodiment, a presentation unit and/or an input device are omitted from a computing device.

In addition, the illustrated computing device 200 includes a network interface 210 coupled to the processor 202 (and, in some embodiments, to the memory 204 as well). The network interface 210 may include, without limitation, a wired network adapter, a wireless network adapter, a mobile telecommunications adapter, or other device capable of communicating to one or more different networks, including the network 112. In some exemplary embodiments, the computing device 200 includes the processor 202 and one or more network interfaces incorporated into or with the processor 202.

Referring again to FIG. 1, the system 100 further includes a reward provider 120 (broadly, reward engine or reward processor) configured, often by computer-readable instructions, to perform the various functions described herein. The reward provider 120 generally includes, or is implemented in, a computing device 200, coupled to network 112. In FIG. 1, the reward provider 120 is illustrated as a standalone part, i.e. operated by a third party, that provides reward processing services to the various other parts of the system 100, or further parts or duplicate parts (not shown). However, it should be appreciated that the reward provider 120 may be incorporated in (or associated with) other parts of the system 100, for example, the payment network 106 (as indicated by the dotted line), the consumer's portable communication device 118, or in (or with) other parts of alternate systems, or parts not shown. Further, while a single reward provider 120 is illustrated, it should be appreciated that in a variety of other embodiments, systems may include multiple reward providers as standalone entities or associated with different parts of the systems (or as combinations thereof).

The reward provider 120 of the system 100 includes a data structure (e.g., as part of memory 204 or separate therefrom, etc.), which comprises multiple reward accounts, each associated with one or more payment accounts provided by the issuer 108 (and/or one or more entities associated with the payment accounts, etc.). In the system 100, for example, the data structure of the reward provider 120 includes a reward account for the consumer 110, associated with the consumer's payment account. As previously described, typically, rewards, such as points, are earned by the consumer 110 based on total amounts of purchase transactions processed to the consumer's payment account. The earned rewards are then accumulated and tracked in the reward account, with notifications of the reward totals often sent to the consumer 110. The rewards can then be subsequently redeemed from the reward account by the consumer 110 as described herein.

The reward provider 120 also includes a data structure, which comprises a reward library (or reward catalog). The reward library may include a variety of products, which may be purchased by the consumer 110 using the reward points accumulated in the consumer's reward account, in total or in part. The products may include products offered to consumers by the merchant 102, or by other merchants, or directly by the issuer 108 (acting as a merchant and, as such, included in the references to a merchant herein, as appropriate). In addition, the reward library may be organized by merchant, by product class, or otherwise, and may be searchable, by the reward provider 120 (or even by the consumer 110), to identify one or more products to the consumer 110, for example, upon request, etc. For example, when the consumer 110 inquires about the product 114 at the merchant 102, the reward provider 120 may identify matching products from the merchant 102 (i.e., products which are the same, or at least the same brand and model number (or product number)), or matching products from multiple different merchants, or further, products usable with or associated with the product 114 from any of the above merchants.

The reward library, in this embodiment, is generated by cooperation between the merchant 102 and the issuer 108. The reward library is accessible to the consumer 110, when seeking to redeem rewards, for example, through the reward provider 120 or through the merchant 102. The products included in the reward library may then be purchased by the consumer 110 using rewards, with the purchase transactions being handled by the merchant 102. It should be appreciated that the reward library, or other reward libraries available through the reward provider 120, may be provided by or maintained at other parts of the system 100 shown in FIG. 1 (e.g., the merchant 102, the payment network 106, the issuer 108, etc.) or not shown (e.g., suppliers etc.), or by parts of other systems. In connection therewith, rewards may then be assigned to the consumers' reward accounts by the other parts of the system 100, or the other parts of other systems.

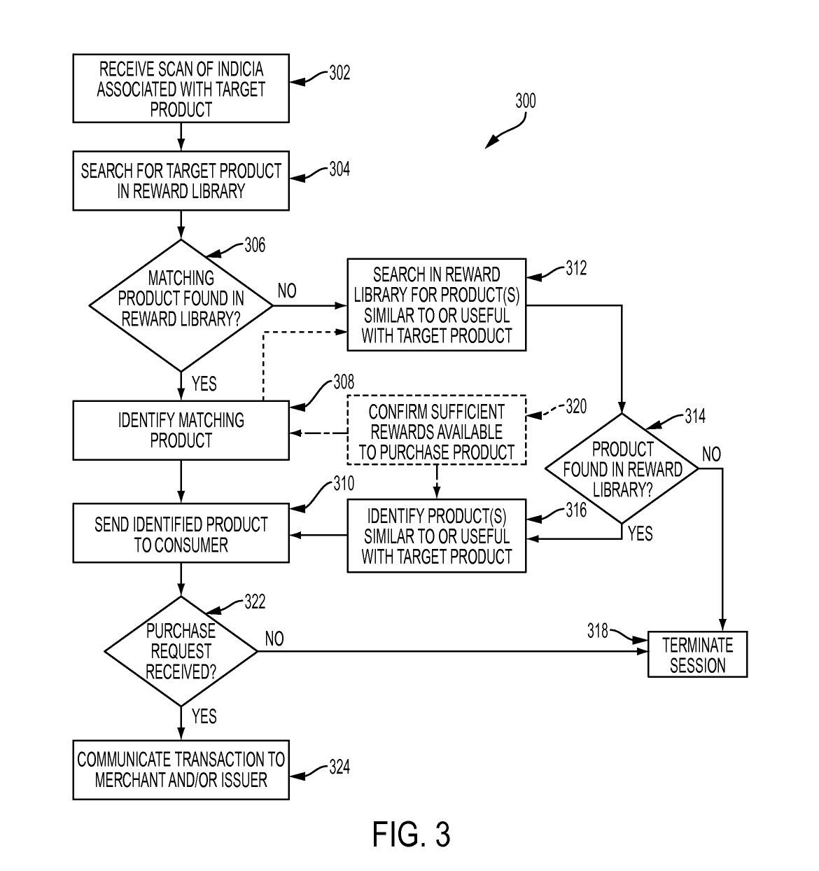

FIG. 3 illustrates exemplary method 300, for use in facilitating a purchase transaction funded with rewards earned by a consumer. The exemplary method 300 is described as implemented in the reward provider 120 of the system 100 with it understood that the reward provider 120 is capable of performing one or more of the various operations of the method 300. Further reference is also made to the merchant 102, the payment network 106, the issuer 108, and the consumer 110. However, the method 300 could be implemented in (or in connection with) one or more other entities, in other embodiments. Further, for purposes of illustration, the exemplary method 300 is also described herein with reference to the computing device 200. However, the methods herein should not be understood to be limited to the exemplary system 100 or the exemplary computing device 200, and the systems and the computing devices herein should not be understood to be limited to the exemplary method 300.

As previously described, the merchant 102 offers various products for sale to consumers. The method 300 is described herein in connection with the merchant 102 offering product 114, as a target product, for sale to the consumer 110.

In connection with viewing the product 114, either at a brick and mortar location of the merchant 102, or virtually (e.g., at presentation unit 206 of the consumer's portable communication device 118, etc.) via a web-based application associated with the merchant 102, the consumer 110 may desire to find a cost of the product 114 in terms of reward points (e.g., a reward cost for the product 114, etc.) based on the consumer's reward account. To accomplish this, the consumer 110 scans the indicia 116 associated with the product 114, for example, using input device 208 of the portable communication device 118 (e.g., a scanner, a camera, etc.). The portable communication device 118, and in particular the processor 202 thereof, is then configured, often by executable instructions (e.g., via a web-based application provided by the reward provider 120, the merchant 102, the payment network 106, the issuer 108, another entity, etc.), to interact with the reward provider 120 and, specifically, to transmit the indicia 116 (which may be the scanned indicia 116 and/or a representation, number or indicator of the scanned indicia 116) to the reward provider 120 via network 112 (e.g., via the Internet as a component of the network 112, via a private network component of the network 112 supported by the reward provider 120, etc.).

In response, the reward provider 120 receives the indicia 116 for the product 114, at 302. The indicia may include the indicia 116 as scanned at the product 114, or some representation of that indicia (e.g., a numeric or alpha-numeric representation of a barcode, QR code, etc.). In various embodiments, the indicia is received from the portable communication device 118, via an application program interface (API) (broadly, a web-based application) accessed by the portable communication device 118. In addition, the reward provider 120 may receive identifying information for the consumer 110 and/or the payment account associated with the consumer 110 (and associated reward account), along with the indicia for the product 114. Further, user credentials for the consumer 110 related to security access, for example, usernames, passwords, etc., may also be received by the reward provider 120 from the consumer 110 along with the indicia for the product 114, or may be required prior to receiving the indicia, in order to authenticate the consumer 110 to the particular payment account and/or reward account through which a purchase transaction may be performed (or to a profile and/or account for the consumer 110 previously established with the reward provider 120 and/or payment network 106). In at least one embodiment, no credentials and/or consumer specific information is required by the reward provider 120 in order to search and/or identify products matching product 114, as described hereinafter.

At 304, the reward provider 120 searches for the product 114 in the reward library, included in the memory 204 of the reward provider 120, based on the received indicia. In particular, the reward provider 120 searches in the reward library for a product (or products) that generally match the product 114, based on the indicia. For example, the reward provider 120 may search for a product in the reward library having the same UPC number, the same SKU code, the same model number, the same product name, the same product description, etc., as the product 114, as identified by the indicia. Or, as described below, the reward provider 120 may search for a product having a similar UPC number, a similar SKU code, a similar model number, a similar product name, a similar product description, etc.

In particular, when a product matching the product 114 is found in the reward library, at 306 (e.g., the same product, or a similar or substitute product, etc.), the reward provider 120 identifies the matching product, at 308, and sends data corresponding to the identified product to the consumer 110, at 310. This may cause the identified product to be displayed to the consumer 110, for example, in one or more interfaces at presentation unit 206 of the consumer's portable communication device 118 (via a web-based application, for example). In sending the data corresponding to the identified product, the reward provider 120 may further include, in the corresponding data, an image of the matching product from the reward library, as well as various details of the product such as, for example, reward cost, non-reward cost, an applicable discount offered by the merchant 102 if the purchase transaction is made with rewards, various specifications for the product, etc., and then cause the same to be displayed to the consumer 110. In various embodiments, the reward cost for the product 114 is less than the non-reward cost for the product 114 (i.e., the reward cost for the product 114 is less than a retail price for the product 114), based on agreement between the merchant 102 and the issuer 108, for example, and the payment network 106. In particular, because use of the consumer's rewards to purchase the product 114 may drive additional sales to the merchant 102, a discounted cost, i.e., the reward cost, may be available to the consumer 110 for the product 114 or other products found in the reward library, and purchased therethrough, or separately at a merchant.

In addition, in sending the data corresponding to the identified product, the reward provider 120 may further provide various options to the consumer 110 to select and purchase, or not, the identified product (e.g., via an interface, etc.). One of the options may include funding the purchase transaction via the consumer's reward account. Further, while the method 300 is directed to facilitating purchase transactions using rewards, it is contemplated that other options may include funding the purchase transaction via a non-reward mechanism, for example, the consumer's payment account, etc., or funding the purchase transaction via a combination of a non-reward mechanism and the consumer's reward account, etc.

With continued reference to FIG. 3, in the method 300, when a matching product is not found (or, optionally even if a matching product is identified at 306 (as indicated by the dotted line)) in the reward library at 306, the reward provider 120 searches in the reward library, at 312, for products that are similar to or useful with the product 114 (i.e., companion products). The reward provider 120 may search for such products, for example, based on the class of product 114, products having one or more similar functions or features to product 114, and/or products identified as companions to or accessory products for product 114 (e.g., a battery and a charging cable may be identified as similar products to a smartphone, etc.), etc. In various embodiments, such similar or companion (or accessory) products may be identified, as companion product(s), by the reward provider 120, through use of a data structure of references defining such products (e.g., merchant designations, previously populated by users and updated by consumer requests, crowdsourcing, historical transaction data for previous purchases for the consumer 110 and other consumers and aggregated purchases, etc.). The data structure may be organized by features, categories, or other aspects of the products, such that the reward provider 120 is able to identify companion or accessory products based on at least one feature or category of the target product. For example, a smartphone may be the target product, whereby the reward provider 120 first searches for the particular smartphone (as indicated by the indicia), and then searches for similar products in a “smartphone” category, or search for one or more features associated with the target product (e.g., screen size, battery life, operating system, manufacturer, etc.), and returned smartphone products with the most common or matching features to the target product, etc. Or, the reward provider 120 may simply return products useful with the smartphone (e.g., charging cables, cases, portable battery charger, etc.), identified in the data structure, as companion or accessory products useful with the target smartphone, as indicated above. The data structure may further be maintained by the reward provider 120 or by other entities as desired or appropriate.

Then, when a product similar to or useful with the product 114 is found (or multiple such products are found), at 314, the reward provider 120 identifies the product, at 316, and sends data corresponding to the identified product to the consumer 110, at 310 (thereby causing the product to be displayed at the consumer's portable communication device 118) (in a similar fashion to that described above). Alternatively, when the reward provider 120 does not find such a product in the reward library, the reward provider 120 terminates the session (and method 300), at 318. The reward provider 120 may transmit a notification to the consumer 110 indicating that no matching products were found, and/or that rewards cannot be used to purchase the scanned product 114. If desired, the consumer 110 (and the reward provider 120) can restart the method 300, at 302, by scanning indicia of another product.

In various embodiments, after finding a match for the product 114 in the reward library, as part of operations 304 and 306, the reward provider 120, consistent with operation 312, may still search for products that are similar to and/or useful with the product 114 as previously described (even when a matching product is found at 306). The products identified may then be displayed at the consumer's portable communication device 118, at 310, alongside the identified matching product. In this manner, the consumer 110 is provided multiple options for redeeming rewards for products which are both generally equivalent to as well as related to the product 114.

Optionally in the method 300 (as indicated by the dotted lines in FIG. 3), the reward provider 120 may determine, at 320, if sufficient rewards are available in the consumer's reward account to purchase the identified product(s). As shown, sufficient rewards may be a condition of identifying products that are matches for and/or products that are similar to or useful with product 114, at 308 and 316. In other embodiments, sufficient rewards may alternatively be a condition of initially searching for the product 114, or displaying identified products to the consumer 110 (i.e., the reward provider 120 may determine if the consumer's reward account has sufficient rewards for a purchase transaction generally at any suitable time within the method 300). In addition, as part of operation 320, the reward provider 120 may also identify a status for the consumer (e.g., standard, gold, platinum, etc.), for example, based on the consumer's payment account, etc., from the issuer 108, from the consumer's portable communication device 118 (e.g., as part of a consumer profile previously established by the consumer 110, etc.). The available rewards and/or consumer status may then be used by the merchant 102, in part, to help determine what discount, or reward cost, to provide to the consumer 110 for any product(s) identified at 308 and 316 and displayed at 310.

Next in the method 300, after the identified product is displayed at the consumer's portable communication device 118, at the presentation unit 206, the consumer 110 makes a decision to purchase or not purchase the product, and when purchasing the product, also makes a decision to fund the purchase by rewards in the consumer's reward account or otherwise. When the consumer 110 decides to purchase the identified product, the consumer 110 provides an input to the portable communication device 118, which in turn sends a purchase request (or purchase with rewards instruction/request) to the reward provider 120. The purchase request includes a product selection (or a selection of multiple products), and may further include one or more credentials for the consumer 110 and/or a payment account associated with the consumer 110.

When the reward provider 120 receives the purchase request from the consumer 110, at 322, it then communicates (e.g., transmits, initiates, etc.) a purchase transaction for the selected product to the merchant 102 and/or the issuer 108, at 324. The merchant 102 and the issuer 108 then cooperate, as described above, to process the purchase transaction based on the selected funding (e.g., rewards, etc.). When the purchase transaction is funded by rewards from the consumer's reward account, the merchant 102 completes the transaction upon confirmation from the issuer 108 that sufficient funds/rewards are available. At that point, the reward provider, or the merchant 102, or the issuer 108 may provide a record of the transaction, or receipt, to the consumer's portable communication device 118. The merchant 102 then causes the products to be delivered to the consumer 110 or, alternatively, permits the products to be picked up at one or more locations associated with the merchant 102. In the instance in which the consumer 110 scanned the product 114 at a brick-and-mortar location of the merchant 102, and completed the transaction with the same merchant 102, the consumer 110 may, in some embodiments, be able to promptly collect the scanned product 114 directly from the merchant 102 (by presenting the record or the transaction to the merchant 102, for example).

Alternatively in the method 300, when the reward provider 120 does not receive a purchase request from the consumer 110, at 322, the reward provider 120 terminates the session at 318 in a similar fashion to that described above.

In some embodiments, the portable communication device 118 associated with the consumer 110 may include a web-based application, which may include aspects consistent with the reward provider 120, which can be used to search for products and/or facilitate purchase transactions by the consumer 110 funded with rewards earned by the consumer 110 (e.g., in accordance with method 300, etc.). For example, the memory 204, and specifically, the non-transitory computer readable storage media associated therewith, may include executable instructions that, when executed by the processor 202, cause the processor 202 to capture or scan, via the input device 208 and in response to a user command from the consumer 110, a product indicia from a target product, for example, indicia 116 of product 114 at merchant 102 in FIG. 1.

The executable instructions may then cause the processor 202 to transmit the indicia 116 (which may include the captured indicia, or a representation, number, or indicator thereof) to the reward provider 120 (associated with the payment account), for searching, or may cause a search for the product based on the product indicia (e.g., via a reward library accessed by the web-based application (via network 112, etc.), as described herein. The processor 202 may, in transmitting the product indicia, include credentials associated with the consumer and/or the consumer's payment account (i.e., associated with the rewards to be used to purchase one or more identified product(s)). Further, the executable instructions permit the consumer's portable communication device 118 to receive data corresponding to one or more products identified in the reward library, and further cause the one or more products to be displayed, at the presentation unit 206, (as described above) along with a cost and a reward cost for the product (and savings compared thereto) (and/or other information about the one or more products included in the corresponding data from the reward provider 120). The processor 202 is then configured to provide a purchase with rewards instruction(s) for the displayed product (e.g., through an API associated with the merchant 102 or issuer 108, etc.) in response to a consumer input to the input device 208, whereby a transaction for the displayed product is transmitted to the merchant 102 and/or issuer 108 (or a different merchant) and funded by rewards associated with the consumer's payment account, as described above.

As can be appreciated, the systems and methods herein may allow consumers to easily locate products from merchants, and view associated costs of the products if purchased using reward points. The systems and methods herein also allow merchants, in connection with agreements with issuers, to use reward points as a means for the consumer to purchase products from the merchants, potentially at discounted prices to help encourage such transactions at the merchants.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be (a) receiving a product indicia associated with a target product offered for sale by a merchant; (b) sending, in response to the indicia, data corresponding to at least one product associated with the product indicia identified in a reward library to the portable communication device, the corresponding data further including a reward cost associated with the at least one product and a reward balance for a payment account associated with the consumer to the portable communication device; (c) receiving, from the portable communication device, a request for a reward purchase of the at least one product using rewards for the payment account; and (d) communicating a transaction request for the at least one product to at least one of the merchant and an issuer of the payment account when the at least one product associated with the product indicia is offered for sale by the merchant.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” “coupled to,” “associated with,” or “included with” another element or layer, it may be directly on, engaged, connected or coupled to, or associated with the other element or layer, or intervening elements or layers may be present. As used herein, the term “and/or” includes any and all combinations of one or more of the associated listed items.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature could be termed a second feature without departing from the teachings of the example embodiments.

What is claimed is:

1. A computer-implemented method for use in purchasing products, by a consumer, with the purchase at least partially funded by rewards for a payment account associated with the consumer, the method comprising:
receiving, from a portable communication device, by a computing device, a product indicia associated with a target product offered for sale by a merchant, the product indicia scanned from the target product by the portable communication device;
sending, by the computing device, in response to the indicia, data corresponding to at least one product associated with the product indicia identified in a reward library to the portable communication device, the corresponding data further including a reward cost associated with the at least one product and a reward balance for a payment account associated with a consumer and the portable communication device;
receiving, by the computing device, from the portable communication device, a request for a purchase of the at least one product at least partially using rewards for the payment account; and
communicating, by the computing device, a transaction request for the at least one product to at least one of the merchant and an issuer of the payment account, when the at least one product associated with the product indicia is offered for sale by the merchant.

2. The method of claim 1, wherein the merchant is a first merchant;
further comprising communicating, by the computing device, said request for the purchase to a second merchant when the at least one product associated with the product indicia is offered for sale by the second merchant; and
wherein communicating the request for the purchase to the second merchant identifies the payment account.

3. The method of claim 1, further comprising searching, in the reward library, for the target product based on the product indicia; and
identifying the at least one product in the reward library.

4. The method of claim 3, wherein the at least one product is identified in the reward library, based on a class of product associated with the target product.

5. The method of claim 3, wherein the corresponding data further includes a non-reward cost associated with the at least one product, the reward cost including a discounted cost over the non-reward cost of the at least one product.

6. The method of claim 3, further comprising causing, by the computing device, a record of the reward purchase to be displayed at the portable communication device.

7. The method of claim 3, wherein communicating said transaction request for the at least one product includes communicating said transaction request only when a reward balance for the payment account exceeds the reward cost for the at least one product.

8. The method of claim 3, wherein the at least one product includes a product having at least one feature in common with the target product.

9. The method of claim 8, wherein the at least one product matches said target product.

10. The method of claim 3, further comprising identifying, by the computing device, at least one companion product in the reward library, based on the product indicia; and
sending, by the computing device, data corresponding to the at least one companion product to the portable communication device.

11. A non-transitory computer readable storage media including executable instructions which, when executed by at least one processor, cause the at least one processor to:
scan, by an input device, a product indicia associated with a target product offered for sale by a merchant;
transmit the product indicia to a reward provider associated with a payment account, the reward provider associated with a reward library;
receive at least one product, from the reward provider, from the reward library, in response to the transmitted product indicia; and
provide a purchase with rewards instruction to the reward provider for the at least one product, in response to a consumer input, whereby a transaction for the at least one product is funded, at least in part, by rewards associated with the payment account.

12. The non-transitory computer readable storage media of claim 11, wherein the transmitted product indicia includes credentials associated with a consumer and/or the payment account of the consumer; and
wherein the executable instructions, when executed by the at least one processor, further cause the at least one processor to display a reward balance associated with the payment account of the consumer, and to display a reward cost associated with the at least one product, the reward cost being less than a non-reward cost for said at least one product.

13. The non-transitory computer readable media of claim 11, wherein the at least one product includes a similar product and/or a product useful with said target product.

14. A portable communication device for purchasing products, by a consumer, with the purchase at least partially funded by rewards for a payment account associated with the consumer, the device comprising:
an input device for scanning product indicia associated with a target product;
a display device;
a network interface; and
a processor coupled to the input device, the display device, and the network interface, the processor configured, by executable instructions, to:
capture, by the input device, in response to a user command, a product indicia from a target product at a merchant;
cause a search for the target product in a reward library, based on the product indicia;
display, at the display device, at least one product based on the search; and
display, at the display device, a reward cost associated with the at least one product.

15. The portable communication device of claim 14, wherein the reward library includes products offered for sale by a second merchant; and
wherein said merchant is a first merchant; and
wherein the processor is further configured to transmit a purchase command to the second merchant, upon selection of the at least one product by a user, the purchase command including an indicator requesting funding of the transaction by rewards associated with the payment account.

16. The portable communication device of claim 14, wherein the reward library is hosted by a computing device associated with the merchant; and
wherein the processor is further configured to access the reward library, in the computing device, at the merchant, thereby causing the search for the target product in the reward library.

17. The portable communication device of claim 16, wherein the at least one product includes a similar product to said product, based on a category, and/or a product useful with said target product.

18. The portable communication device of claim 14, wherein said merchant is a first merchant, and wherein the reward library is hosted by a computing device associated with a second merchant; and
wherein the processor is configured to access the reward library, in the computing device, at the second merchant, thereby causing the search for the target product in the reward library.

19. The portable communication device of claim 14, further comprising a second input device coupled to the processor for providing user inputs to the portable communication device; and
wherein the processor is further configured to provide a purchase with rewards instruction for the at least one product, in response to a user input to the second input device, by the consumer, to at least one of the merchant and a reward provider associated with the reward library, whereby a transaction for the at least one product is transmitted through a payment network and funded by rewards associated with the payment account.

20. The portable communication device of claim 14, wherein the at least one product includes multiple products, at least one of the multiple products including at least one companion product to the target product.
